(19) United States
(12) Patent Application Publication
(10) Pub. No.: US 2006/0212312 A1
(43) Pub. Date: Sep. 21, 2006

(54) Healthcare notification system

(75) Inventors: Edward J. Fotsch, Sausalito, CA (US); Debra Fotsch, Sausalito, CA (US)

Correspondence Address: VIERRA MAGEN MARCUS & DENIRO LLP, 575 MARKET STREET SUITE 2500, SAN FRANCISCO, CA, 94105, US

(73) Assignee: Medem, Inc.

(21) Appl. No.: 11/086,118

(22) Filed: Mar. 21, 2005

(51) Int. Cl. G06Q 10/00

(52) U.S. Cl. 705/2

(57) ABSTRACT

Methods and apparatus enabling organizations with a need to communicate with healthcare providers regarding health-related issues affecting patient health to notify healthcare providers of a health-related issue affecting patient health are disclosed. An electronic notification of the health-related issue is transmitted by one of the organizations to a healthcare notification network for transmission to a healthcare provider, where the electronic notification includes a mechanism for obtaining an acknowledgement indicating that the healthcare provider has received and opened the electronic notification. The acknowledgement is then received by the network from the healthcare provider, where the acknowledgement indicates that the healthcare provider has received and opened the electronic notification. In response to the notification received from the organization, the healthcare provider transmits a notification of the health-related issue to the affected patients.

### RELATED APPLICATIONS

This application is related to Attorney Docket No. MDMPP001, patent application Ser. No. 10/387,041, entitled “HEALTHCARE PROVIDER-PATIENT ONLINE CONSULTATION SYSTEM,” filed on Mar. 10, 2003, naming Fotsch et al. as inventors, which is incorporated herein by reference for all purposes.

This application is related to Attorney Docket No. MDMPP001X1, patent application Ser. No. 10/641,982, entitled “HEALTHCARE PROVIDER-PATIENT ONLINE CONSULTATION AND COMPLIANCE PROGRAM,” listing Fotsch et al. as inventors, filed on Aug. 15, 2003, which is incorporated herein by reference for all purposes.

This application is also related to Attorney Docket No. MDMPP002, patent application Ser. No. ______, entitled “ELECTRONIC PERSONAL HEALTH RECORD SYSTEM,” filed herewith, naming Fotsch et al. as inventors, which is incorporated herein for all purposes.

### BACKGROUND OF THE INVENTION

1. Field of the Invention

The present invention relates to an online healthcare notification system. More particularly, the present invention relates to agency-physician communications supporting healthcare notifications and acknowledgements via the Internet.

2. Description of the Related Art

Timely, accurate, reliable and pervasive communication with physicians and patients is required for patient protection and safety, and for national defense against biological or communicable threats. But despite advancements in information and communication technology, most direct outreach to physicians and patients related to patient safety, product warnings or public health issues continue to rely on broadcast media and U.S. mail. Over 250 times each year, manufacturers, federal agencies and other third parties outreach directly to physicians, principally using the U.S. mail. Most of these messages relate not only to physicians themselves, but also directly to the patients in their care. These physicians, however, have no practical means by which to outreach to their patients and share the information, warnings, recalls or patient safety messages. In addition, mail-based physician outreach has inconsistent results and poor documentation.

Communicating efficiently and effectively with physicians and patients is critical to ensure patient and public safety. Manufacturers of healthcare products and services are at times required to contact physicians with information regarding their products and services. The information may be a product recall, warning, or other information of importance. In 2003 alone, there were a combined total of over 50 Class 1 FDA-mandated medication and device recalls, nearly all of which required direct notification of large numbers, typically hundreds of thousands, of physicians. In March 2004, over 100 medications had FDA-approved label changes, most related to new contraindications and warnings. Currently, the principal method for communicating FDA-related product recalls or warnings directly to physicians is the U.S. mail. The current method for communicating FDA-related product recalls or warnings to patients/consumers is through press releases and media, and physician notification of their patients using telephone or US mail.

In addition to FDA-related notifications, federal agencies and other public health advocates such as the Centers for Disease Control (the “CDC”) also have a need to communicate rapidly with physicians in the event of a natural disaster, communicable outbreak, bioterrorism or other similar events. For the most part, current communication to physicians by government agencies related to emergent public safety is via media, fragmented outreach to local health systems, or the US Mail. Federally funded AHRQ studies from 2002 and 2004 demonstrated that while information technology held clear promise as a vehicle for physician communication in the event of emergent public health needs, the current notification systems are fragmented and under-funded, leaving the country and its citizens vulnerable.

As set forth above, there are many circumstances requiring that physicians or other individuals be contacted regarding situations affecting public health and safety. For instance, product recalls, warnings or label changes on medications may affect the health and safety of individuals taking these medications. Other possible scenarios affecting groups of individuals may include attempts at bio-terrorism or local epidemic outbreaks. In these circumstances, it is important e to notify the affected individuals in a timely manner. The Federal Drug Administration (FDA) and the Centers for Disease Control (CDC) are among those charged with the responsibility of ensuring that members of the public are notified when these situations arise. Typically, organizations such as the FDA, the CDC, and pharmaceutical companies (among others) communicate with physician practices via U.S. mail. However, there is no way to ensure that the physicians have opened their mail. Moreover, there is generally a significant time delay between the time that mail is sent and the time that mail is received. In fact, after printing and handling, the U.S. mail typically takes several days to reach addressees. Moreover, U.S. mail that is not delivered appropriately often results in no, or delayed, notification to the sender. In some circumstances, Federal Express may be used in urgent situations. However, this option is costly and therefore only done in rare circumstances. Moreover, even with Federal Express, a day can be a significant amount of time when a person's health or safety is involved. In addition, physicians' addresses often change without timely notification. Even when the physician has received the mailed notification, there is no guarantee that the physician will open his or her mail, or that the appropriate patients will be notified by the physician. Unfortunately, there is currently no efficient mechanism in place to enable physicians to notify their patients, often resulting in further notifications to be sent via U.S. mail, if at all.

In conjunction with product recalls, warnings and other similar notifications, the FDA will often mandate that the responsible manufacturer conduct follow up studies to determine the efficacy of the mailing. These studies involve making contact with the physicians to ensure that the letter was received and read, and that the physician then notified his or her patients of the health-related issue addressed in the letter sent to the physician. While it is possible to confirm delivery of U.S. mail, this confirmation is limited to receipt of the mail piece only. Unfortunately, there is no efficient way for such a company to perform this research to ensure that the physician actually received and read the notification, and then took the appropriate measures to ensure that his or her patients were notified. In addition, the physician may require more information than is typically contained in the notification, and because the notification is paper-based, several more steps are required for the physician to obtain access to this additional information.

It is also important to note that there is currently no mechanism in place for notifying the affected individuals, such as patients of physicians or those who care for them, of the types of developments set forth above, nor is there any way to effect broader outreach to all individuals in a particular area, for example, when a local or regional health crisis occurs. This is also true and becomes even more challenging on a nationwide scale, when notification might be required in the event of a bioterrorism event. For this reason and due to the time delays involved with mailing health-related notifications to physicians, the FDA and the CDC often turn to the media, such as television or radio, to notify the public of emergency or health-related situations. In this manner, the general public may be notified in a more efficient manner. Unfortunately, there is no guarantee that the notifications or warnings will reach the desired individuals.

In view of the above, it would be beneficial if a more efficient mechanism for notifying physicians and patients of health-related matters could be implemented.

### SUMMARY OF THE INVENTION

Methods and apparatus for supporting communications between healthcare providers and organizations with a need to communicate with the healthcare providers regarding issues affecting patient health are disclosed. This is accomplished, in part, via a communication network supporting communication between the organizations and the healthcare providers. In this manner, healthcare providers may be notified of health-related issues affecting the health of their patients.

In accordance with one aspect of the invention, a network that can provide immediate and direct communication with healthcare providers regarding issues affecting patient or general population health is provided. Issues affecting patient or general population health may arise under a variety of circumstances. For instance, it may be necessary to notify healthcare providers of product recalls or label changes on medications. Other possible scenarios affecting the general population may include bio-terrorism outbreaks or local epidemics. The Federal Drug Administration (FDA) and manufacturers are charged with the responsibility of notifying patients in the event of a product recall, warning or label change, and the Centers for Disease Control (CDC) and other government agencies bear the responsibility of notifying the public in the event of a local, regional or national public health threat. Thus, the organizations communicating with healthcare providers via the network may include the FDA, CDC, and other federal agencies, as well as other companies or organizations, such as those that are governed by the FDA.

In the disclosed embodiments detailed below, a healthcare provider may be a healthcare provider authorized to practice medicine, such as a physician, nurse, physician's assistant, opthomologist, dentist, or nurse-practitioner. Healthcare providers may also include chiropractors and optometrists. In addition, healthcare providers may include service providers, such as pharmacists and lab technicians, which provide services to primary healthcare providers such as physicians. A healthcare provider such as a physician's assistant need not be capable of practicing independently. Rather, they merely need to be subservient to a healthcare provider (e.g., physician) and working within the healthcare provider's practice group, such as where the healthcare provider is associated with a healthcare provider-controlled network. In order to simplify the following description, a physician healthcare notification system will be described. However, it will be understood that the disclosed system may also be used to support communication between organizations and healthcare providers other than physicians.

In accordance with one embodiment, embodiments of the invention fulfill FDA regulatory requirements. The FDA regulatory requirements include a notification aspect enabling physicians to be notified of health-related issues. In addition, the FDA regulatory requirements also include a follow-up aspect ensuring that the physicians received the notification transmitted to them and that their patients were notified. In order to satisfy these regulatory requirements, a notification mechanism and acknowledgement mechanism are implemented, as will be described in further detail below.

In accordance with one embodiment, a notification mechanism is implemented that enables organizations such as the CDC or FDA (or companies governed by the FDA) to make contact with healthcare providers such as physicians regarding issues affecting patient health. Specifically, the notification mechanism enables a notification to be generated and transmitted via electronic mail on behalf of an organization to healthcare providers. The electronic mail may include the substance of the notification, or may include a link to a web page that includes at least a portion of the notification.

In addition, in accordance with one embodiment, an acknowledgement mechanism is implemented that enables an acknowledgement message to be transmitted back to the network and then reported to the corresponding organization. The acknowledgement message may be transmitted automatically or in response to input by the healthcare provider. The acknowledgement message, at minimum, should indicate that the healthcare provider has received and opened the notification message. In addition, the acknowledgement message may indicate that the healthcare provider has read and understands the notification. In addition, the acknowledgement message may indicate that the healthcare provider will follow or has followed the instructions provided in the notification message or, alternatively, that the healthcare provider will notify or has notified patients of the issue affecting patient health that has been identified in the notification message.

In accordance with one aspect of the invention, once a notification message is received by a healthcare provider, the healthcare provider sends another notification message (or forwards the initial notification message) to the appropriate patients. This may be accomplished via a network to which the healthcare providers and the patients are members. (This network may be the same network, or a different network, from the network used by organizations to reach healthcare providers with the notification messages.) The healthcare provider may choose to send a notification message to all of their patients. Alternatively, the healthcare provider may choose to identify the patients to which the health-related issue pertains, thereby enabling the healthcare provider to send a notification message to that particular subset of patients.

In accordance with one embodiment, the healthcare provider may identify the appropriate subset of patients via an online health record system that stores a plurality of patient records. By searching the online health record system, the healthcare provider may identify the appropriate subset of patients to which the health-related issue pertains.

In accordance with yet another aspect of the invention, the communication network supporting communications between agencies/companies and physicians is facilitated via one or more individuals associated with the network. Specifically, although healthcare providers may have direct access to the network to transmit messages via the network, agencies or companies must submit communications for review by the individuals employed by the network before it can be transmitted to healthcare providers via the network. This governing body then reviews the communications to ensure that it meets the criteria for delivery to healthcare providers via this network. Assuming the communications meet this criteria, the information or a portion thereof is transmitted to healthcare providers via the network. Similarly, when responses are received from healthcare providers, these responses may be compiled by the individuals with regard to “fulfillment” of the action required of the communication by the agencies. In this manner, the employees of the network control access to the network by agencies and companies, as well as manage reports generated for use by these agencies and companies.

These and other features of the present invention will be described in more detail below in the detailed description of the invention and in conjunction with the following figures.

### BRIEF DESCRIPTION OF THE DRAWINGS

FIG. 1 is a system diagram illustrating a system in which the present invention may be implemented.

FIG. 2 is an exemplary HTML email including a notification that may be transmitted to healthcare providers.

FIG. 3 is an exemplary non-HTML email with a link to an HTML web page including notification that may be transmitted to healthcare providers.

FIG. 4 is an exemplary HTML web page with notification and physician response survey that may be transmitted to healthcare providers.

FIG. 5 is an exemplary HTML notification with a physician response survey that may be transmitted to healthcare providers.

FIG. 6 is a diagram illustrating an exemplary system in which the present invention may be implemented.

### DETAILED DESCRIPTION OF THE INVENTION

In the following description, numerous specific details are set forth in order to provide a thorough understanding of the present invention. It will be obvious, however, to one skilled in the art, that the present invention may be practiced without some or all of these specific details. In other instances, well known process steps have not been described in detail in order not to unnecessarily obscure the present invention.

The present invention supports online healthcare provider-organization notifications and acknowledgements via the Internet. In this example, the healthcare provider is a physician. Thus, the following example will refer to physician-organization communications. The terms healthcare provider and physician will be used interchangeably herein. However, it is important to note that the healthcare provider need not be a physician.

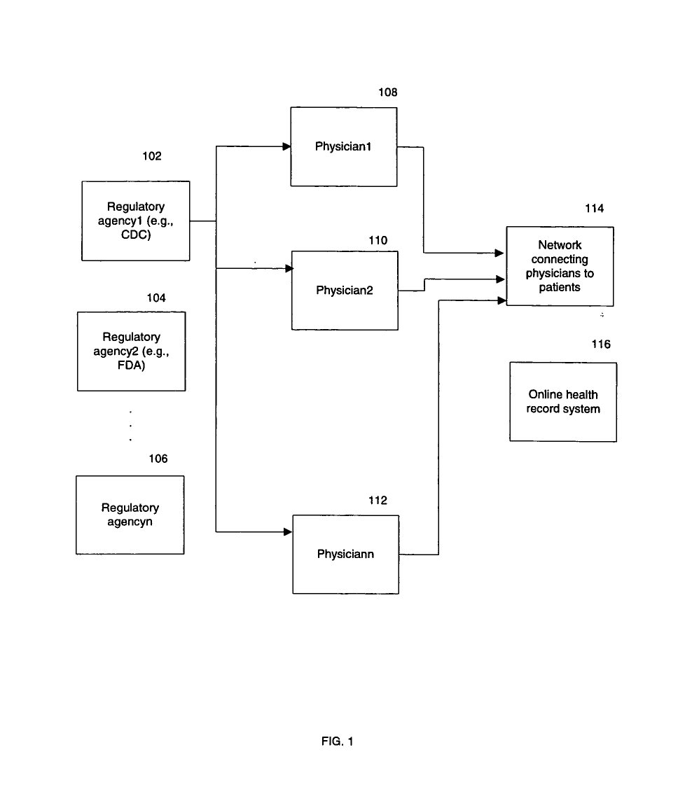

FIG. 1 is a system diagram illustrating a system in which the present invention may be implemented. Specifically, the system enables organizations to communicate with healthcare providers regarding health-related issues affecting patient health. The organizations may include any organizations with a need to communicate with healthcare providers (e.g., physicians) on a local, regional or national level regarding health-related issues affecting patient health, such as the CDC or FDA. The health-related issue may, for example, pertain to issues such as those related to a product (e.g. product recall), food, medical device, or a drug (e.g., drug recall or correction, such as a label change), an epidemic, or bio-terrorism alert. Other examples may include newly discovered information about a medication such as drug interactions, use of the drug with patients with various medical disorders, or modifications to the proper dosage and administration of the drug.

In this example, a healthcare notification network enables communication on behalf of organizations such as regulatory agencies 102, 104, 106 to healthcare providers such as physicians 108, 110, 112. This may be accomplished, for example, through registration of the organizations and physicians with the network. In this manner, regulatory agencies such as the FDA or the CDC may communicate with healthcare providers such as physicians.

While it is possible that email may be used to support communication between the regulatory agencies 102, 104, 106 and the healthcare providers 108, 110, 112, there is currently no national professional healthcare email network. Through the use of a healthcare notification network, healthcare providers may access communications from these agencies. Similarly, the agencies may also receive responses from the healthcare providers, via the network, in response to the notifications. These communications may be secured (e.g., via username and password) or unsecured. The healthcare notification network enables notifications to be composed and delivered to physicians via email, as well as acknowledgements to be delivered back to the network, and then on to the organizations in response to the notifications, as will be described in further detail below.

In the example shown in FIG. 1, the regulatory agency 102 (e.g., CDC) sends an electronic notification for a particular health-related issue to the network, for distribution to one or more healthcare providers. The electronic notification may also include a mechanism for obtaining an acknowledgement indicating, at minimum, that the healthcare provider has received and opened the electronic notification. In this manner, the regulatory agency 102 may receive information from the network regarding an acknowledgement from the healthcare provider indicating that the healthcare provider has received and opened the electronic notification. The acknowledgement may also indicate that the healthcare provider has read the electronic notification, as well as indicate that the healthcare provider has followed or agrees to follow the instructions in the notification and/or that the healthcare provider has notified or will notify patients affected by the health-related issue. Other organizations 104, 106 (e.g., companies or regulatory agencies) may transmit or have electronic notifications transmitted and receive acknowledgements in a similar manner. From the acknowledgements (or reports thereon), the organizations 102, 104, 106 may compile the appropriate reports in compliance with FDA and CDC regulations.

Once a healthcare provider (e.g., physician) has been notified of a particular health-related issue, they should notify the appropriate patients. This may be accomplished, for example, by notifying the patients via a network 114 connecting the physician(s) to their patients. In other words, the network 114 may be a network to which the healthcare provider and their patients belong. This notification may be a new notification message that is automatically generated or manually composed by the healthcare provider. Alternatively, the healthcare provider may choose to forward the notification received by the healthcare provider to the affected patients, when an organization has given the physician a notification that is appropriate for distribution to patients. The network 114 may be a part of the network that enables communication between the organizations and the healthcare providers or, alternatively, the network 114 may be a separate network connecting the healthcare providers to their patients. One such network connecting healthcare providers with patients is described in further detail in Attorney Docket No. MDMPP001, Patent Application Serial No. 10/387,041, entitled “HEALTHCARE PROVIDER-PATIENT ONLINE CONSULTATION SYSTEM,” filed on Mar. 10, 2003, naming Fotsch et al as inventors, which is incorporated herein by reference for all purposes. Through this network, secure and confidential communications between healthcare providers and patients is supported (e.g., via registration and login using a username/user ID and password).

The healthcare provider may send an appropriate notification message to all of his or her patients. Alternatively, the healthcare provider may identify the patients affected by the particular health-related issue identified in the notification message received by the healthcare provider. In order to identify the affected patients, the healthcare provider may search an online health record system 116 storing health records for a plurality of patients to identify the subset of his or her patients affected by the particular health-related issue. For instance, the healthcare provider may search the online health record system 116 for patients affected by a particular medical condition and/or taking a particular medication. An exemplary online health record system is described in further detail in Attorney Docket No. MDMPP002, patent application Ser. No. ______, entitled “ELECTRONIC PERSONAL HEALTH RECORD SYSTEM,” naming Fotsch et al as inventors. In this manner, a healthcare provider may identify a segment of their patients affected by the health-related issue identified in a notification received from an organization such as the FDA or the CDC.

The electronic notification may be implemented in a variety of forms, and in accordance with a variety of formats and protocols. For instance, the electronic notification may be sent in the form of an electronic mail message. The electronic notification (e.g., electronic mail message) may also include a link to a web page that includes at least a part of the content of the electronic notification. The electronic mail message containing the notification can be sent to a computer email system, a pager, a cell phone, or other device, or some combination of the above, that will enable immediate access to the information by the healthcare provider.

Similarly, the acknowledgement may be transmitted by a healthcare provider to the network or organization that transmitted the electronic notification in a variety of forms, and in accordance with a variety of formats and protocols. For instance, the acknowledgement may be sent in the form of an electronic mail, or may be submitted via a web site such as that referenced in the link from the electronic notification.

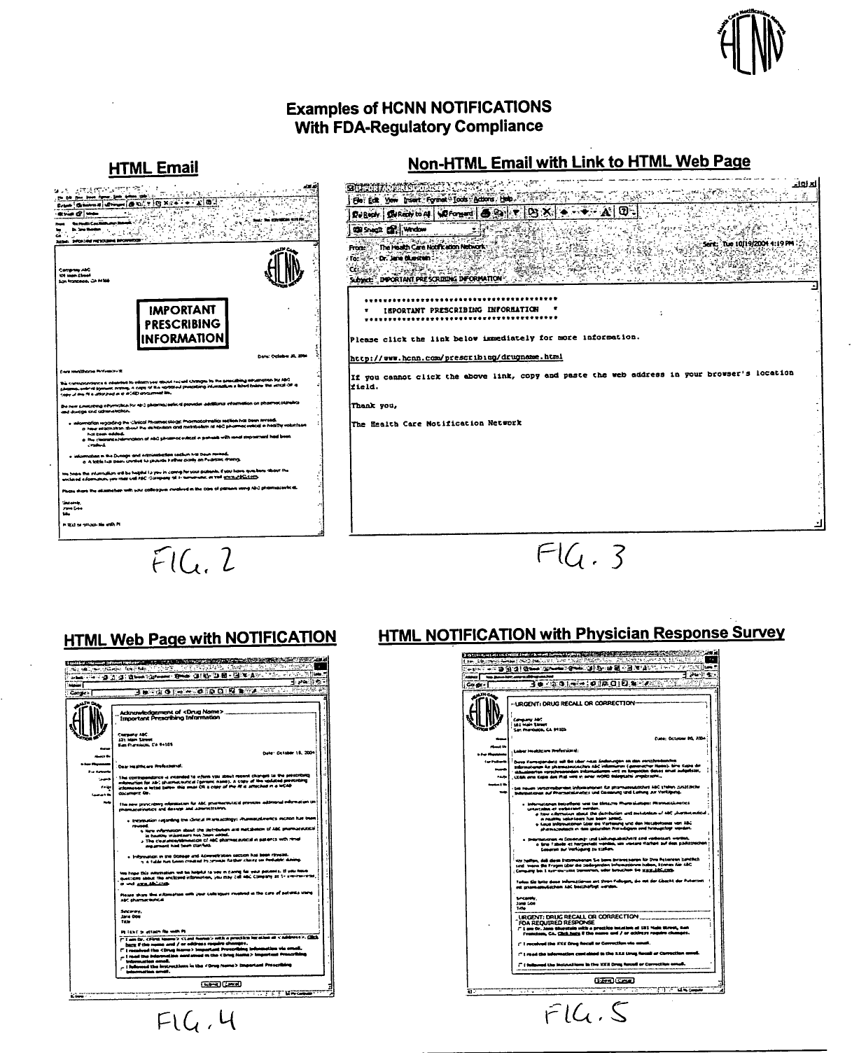

It is also important to note that the acknowledgement may also be sent automatically to the network or organization in the form of an automated response, as well as in response to input by the healthcare provider. For instance, an automated response may be implemented via an HTML tag, as will be described in further detail below. This is particularly useful, for example, in notifying the network, and then the organization, that the healthcare provider has received and opened the corresponding notification, since the healthcare provider may not be required to respond to a particular notification, or forget to respond to the notification. FIGS. 2-5 present exemplary mechanisms for transmitting a notification to a healthcare provider, as well as exemplary mechanisms for obtaining an acknowledgement from the healthcare provider.

It is important to note that, while conventional email systems may be used to transmit notifications, FDA regulations currently require that notifications sent to physicians use specific font sizes and colors. In order to fulfill such requirements, in accordance with one embodiment, HTML-type viewing of the notification is supported. This may be accomplished via an HTML email or an email with a link to a HTML web page.

In accordance with various embodiments, a notification email may be sent in HTML format, as well as non-HTML format. FIG. 2 is an exemplary HTML email including a notification that may be transmitted to healthcare providers. This exemplary email pertains to prescribing information. Specifically, in this example, new information about the distribution and metabolism of the identified drug is provided. In addition, the affect of the medication on patients with renal impairment is clarified, and information regarding the dosage and administration of the drug is clarified with respect to pediatric dosing.

In accordance with one embodiment, if the recipient has an HTML-capable email application, the HTML email will be opened and an HTML tag in the HTML email will report receipt back to the healthcare notification network, thereby supporting automated acknowledgement in response to the notification. In some embodiments or if the recipient's email application is not HTML-capable, the recipient receives a simple message (in HTML or non-HTML format) that an important patient safety message is available through a hypertext link embedded in the email. The recipient then clicks on the link and is taken to an HTML web page. At that time, an HTML tag may be reported to the healthcare notification network. In accordance with one embodiment, the HTML tag will carry the information necessary to accurately identify the healthcare provider.

As set forth above, rather than providing the relevant information in the email itself, the information (or portion thereof) may be provided in a separate web page. FIG. 3 is an exemplary non-HTML email with a link to an HTML web page including a notification that may be transmitted to healthcare providers. In this example, the notification is not provided in the email, but in the web page. Thus, the user must access the web page referenced in the email to read the notification.

As set forth above, a HTML notification may be provided in the form of a link to a HTML web page or HTML email. FIG. 4 is an exemplary HTML web page with notification and physician response survey that may be transmitted to healthcare providers, while FIG. 5 is an exemplary HTML notification with a physician response survey that may be transmitted to healthcare providers.

As shown in both FIGS. 4 and 5, the notification may include a mechanism for obtaining an acknowledgement, which may be in the form of a physician response survey (as shown). The physician response survey may be accessed when the user accesses the web page (as shown), or alternatively, may be accessed when the user reads the electronic notification (e.g., email). The physician response survey includes one or more questions or entries requiring a response by the healthcare provider.

In this example, the physician response survey enables a healthcare provider to confirm his or her identity, as well as submit any name or address changes. Moreover, the healthcare provider may indicate that he or she has followed or will follow the instructions provided in the electronic notification (as shown), or more specifically, the healthcare provider may indicate that he or she has notified or will notify patients affected by the health-related issue.

The above-described embodiments may be used to notify healthcare providers (e.g., physicians) of issues affecting patient health. Thus, the notifications and content thereof may comply with FDA and/or CDC regulations. For instance, FDA regulations may be found in the ORA/Office of Enforcement, Division of Compliance Management and Operations Guidance for Industry, Product Recalls, including Removals and Corrections, which may be found at HTTP://www. www.fda.gov/ora/compliance_ref/recalls/ggp_recall.htm, which is incorporated herein by reference. In accordance with such regulations, information may include a description or identification of the product that is the subject of the notification. The description or identifying information may include information such as the identity of the manufacturer, as well as the identity of the recalling firm (e.g., manufacturer, importer, broker, repacker, or own-label distributor). The information provided in the notification may also include the identity of the firm responsible for the violation or problem, as well as the reason for the recall or notification. Furthermore, the notification may also include a health hazard assessment including an assessment of the health risk. Finally, the notification may provide instructions to the patients, such as returning the product, discontinued use of the product, or modification of dosage or other instructions for modified use of the product in accordance with the notification.

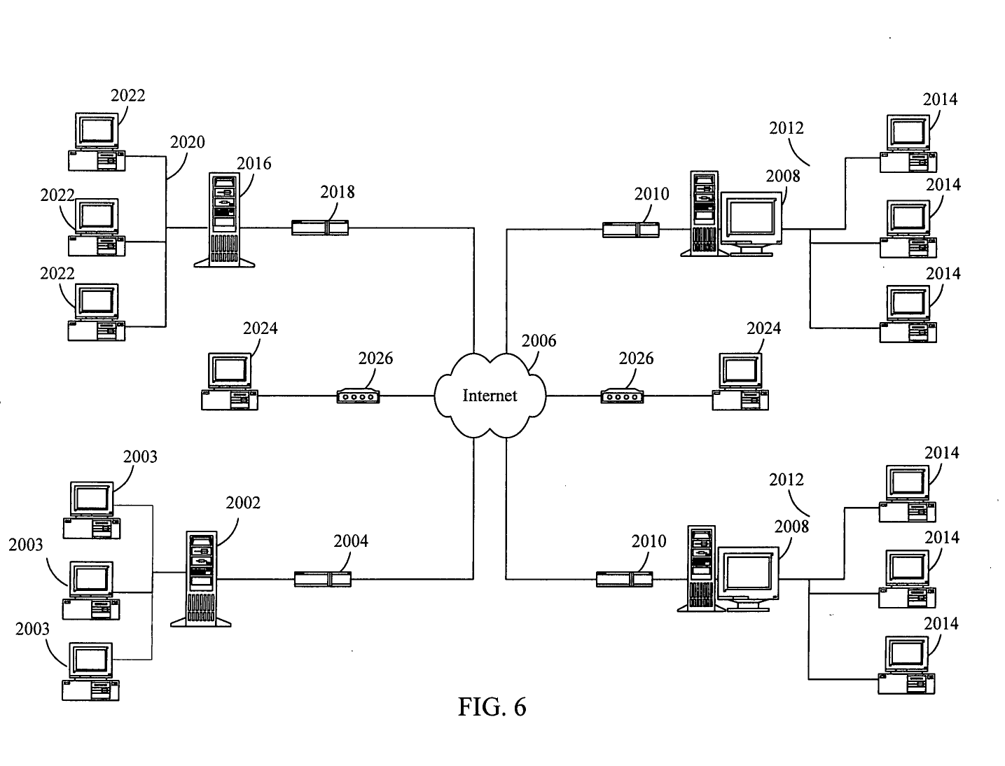

FIG. 6 is a block diagram of a hardware environment in which the various embodiments of the healthcare notification network may be implemented in order to facilitate communication between organizations and healthcare providers. The healthcare notification network through which communications between organizations and one or more physicians are facilitated according to the invention and the network itself through which these notifications are sent may be include a server 2002, which is connected by a router 2004 to the Internet 2006. Employees of the network at computers 2003 may be coupled to the server 2002 to receive communications from organizations. Once the employees review the communications and deemed them appropriate for transmission, they may transmit them to healthcare providers by the router 2004 via the Internet 2006.

In addition, physician office computers 2008 may also be connected to the Internet via routers 2010 in order to receive the transmission of e-mails from the server 2002 and transmit acknowledgement messages to the server 2002 (e.g., via answering a survey or automatically). The physician office computers 2008 may run software as well as store messages such as notification messages received by the physicians. Physician office computers 2008 may have networks 2012 associated therewith interconnecting a plurality of personal computers or work stations 2014. In this manner, an office network may access received emails from the email client through the server 2002. Organizations (e.g., agencies) (represented by computers 2022 and 2024) may be connected to the Internet in a variety of ways for transmission of messages to the network. For example, an agency worker employed by an agency may be connected from his home via a modem 2026, or from his workplace via a network 2020, a file server 2016, and a router 2018. It will be understood that, according to various embodiments of the invention, employees of such organizations or agencies may gain access to the Internet for transmission of information to the network and then on to the healthcare provider via a variety of hardware configurations. Similarly, such employees may be coupled to a web site on server 2002 in order to gain access to the server 2002 and to initiate the transmission of communications such as e-mail notifications to the network, for distribution to one or more physicians. Similarly, an employee may access the network 2002 or web site from his computer 2014 at his place of employment. It will also be understood that the hardware environment of FIG. 6 is shown for illustrative purposes and that a wide variety of hardware environments may be employed to implement the various embodiments of the present invention. It should also be understood that specific embodiments of the methods and processes described herein may be implemented as computer program instructions, i.e., software, in the memory of the computers and servers.

Although illustrative embodiments and applications of this invention are shown and described herein, many variations and modifications are possible which remain within the concept, scope, and spirit of the invention, and these variations would become clear to those of ordinary skill in the art after perusal of this application. For instance, the present invention is based upon the generation and transmission of notification messages via email and/or web site. However, it should be understood that the present invention is not limited to this arrangement, but instead would equally apply regardless of the mode of transmission or system configuration, including the use of pagers, cell phones, or other instruments as receiving devices for the notifications. Accordingly, the present embodiments are to be considered as illustrative and not restrictive, and the invention is not to be limited to the details given herein, but may be modified within the scope and equivalents of the appended claims.

What is claimed is:

1. In a network, a method of notifying a healthcare provider of a health-related issue affecting patient health by an organization with a need to communicate with healthcare providers regarding health-related issues affecting patient health, the method comprising:
sending an electronic notification of the health-related issue received from an organization to a healthcare provider, the electronic notification including a mechanism for obtaining an acknowledgement indicating that the healthcare provider has received and opened the electronic notification;
receiving the acknowledgement by the network from the healthcare provider, the acknowledgement indicating that the healthcare provider has received and opened the electronic notification.

2. The method as recited in claim 1, wherein sending is performed from the organization to the network and then from the network to the healthcare provider.

3. The method as recited in claim 1, wherein the electronic notification fulfills FDA regulations.

4. The method as recited in claim 1, wherein the electronic notification is composed using a font size and color conforming to FDA regulations.

5. The method as recited in claim 1, wherein the acknowledgement is received via electronic mail.

6. The method as recited in claim 1, wherein the acknowledgement is received via a web site.

7. The method as recited in claim 1, wherein the electronic notification further includes a mechanism for obtaining an acknowledgement that indicates that the healthcare provider has read the electronic notification, the method further comprising:
obtaining the acknowledgement that indicates that the healthcare provider has read the electronic notification.

8. The method as recited in claim 1, wherein the electronic notification further includes a mechanism for obtaining an acknowledgement that indicates that the healthcare provider has followed or will follow instructions provided in the electronic notification, the method further comprising:
obtaining the acknowledgement that indicates that the healthcare provider has followed or will follow instructions provided in the electronic notification.

9. The method as recited in claim 8, wherein the acknowledgement is obtained via electronic mail.

10. The method as recited in claim 8, wherein the acknowledgement is obtained via a web site.

11. The method as recited in claim 1, wherein the electronic notification further includes a mechanism for obtaining an acknowledgement that indicates that the healthcare provider has notified or will notify patients affected by the health-related issue, the method further comprising:
obtaining the acknowledgement that indicates that the healthcare provider has notified or will notify patients affected by the health-related issue.

12. The method as recited in claim 11, wherein the acknowledgement is obtained via electronic mail.

13. The method as recited in claim 11, wherein the acknowledgement is obtained via a web site.

14. The method as recited in claim 1, wherein the electronic notification includes a survey including one or more questions or entries requiring a response by the healthcare provider.

15. The method as recited in claim 1, wherein the electronic notification is an electronic email.

16. The method as recited in claim 15, wherein the electronic email includes a link to a web page.

17. The method as recited in claim 1, wherein the organization is the FDA or CDC.

18. The method as recited in claim 1, wherein the health-related issue pertains to a medication or an epidemic.

19. The method as recited in claim 1, wherein the electronic communication and acknowledgement are transmitted via a health care notification network on behalf of the organization to the healthcare providers.

20. The method as recited in claim 1, further comprising:
identifying by the healthcare provider one or more patients affected by the health-related issue; and
transmitting a notification of the health-related issue from the healthcare provider to the identified patients.

21. The method as recited in claim 20, wherein identifying comprises:
identifying the patients via an online health record system including health records of a plurality of patients.

22. The method as recited in claim 20, wherein transmitting the notification of the health-related issue from the healthcare provider to the identified patients is performed via a network to which the healthcare provider and the identified patients belong

23. The method as recited in claim 21, wherein the electronic communication and acknowledgement are transmitted via a health care notification network on behalf of the organization to the healthcare providers, wherein the network to which the healthcare provider and the identified patients belong and the healthcare notification network that communicates to healthcare providers on behalf of the organizations are different networks.

24. A system supporting communication between healthcare providers and patients regarding issues affecting the health of the patients, comprising:
a first computer network facilitating communication between the healthcare providers and organizations with a need to communicate with the healthcare providers on matters affecting patient health;
a notification mechanism supporting generation and transmission of notifications by the organizations to the healthcare providers via the first computer network, the notifications each notifying the healthcare providers of a health-related issue affecting patient health; and
a second computer network connecting the healthcare providers and their patients, wherein the second computer network supports secured communications between the healthcare providers and their patients.

25. The system as recited in claim 24, wherein the secured communications are accessible via a user ID and password.

26. The system as recited in claim 24, wherein the notification mechanism further supports acknowledgements transmitted by the healthcare providers indicating that the corresponding one of the healthcare providers has read the corresponding notification.

27. The system as recited in claim 26, wherein the notification mechanism further provides for an automated response to the network or corresponding organization indicating that the corresponding one of the healthcare providers has received and opened the corresponding notification.

28. The system as recited in claim 27, wherein the automated response is implemented via an HTML tag.

29. The system as recited in claim 26, wherein the acknowledgements transmitted by the healthcare providers further indicate that the healthcare providers have notified or will notify the affected patients.

30. The system as recited in claim 26, wherein the acknowledgements transmitted by the healthcare providers further indicates that the healthcare providers have or will follow the instructions provided in the corresponding notification.

31. The system as recited in claim 24, further comprising:
an online health record system accessible by the healthcare providers, the online health record system enabling the healthcare providers to identify a set of their patients affected by a notification received by one of the organizations.

32. The system as recited in claim 24, wherein the notification mechanism fulfills FDA regulatory requirements.

33. The method as recited in claim 24, wherein the organizations include at least one of the CDC and FDA.
